(19) United States
(12) Patent Application Publication
(10) Pub. No.: US 2012/0005274 A1
(43) Pub. Date: Jan. 5, 2012

(54) SYSTEM AND METHOD FOR OFFERING CLOUD COMPUTING SERVICE

(75) Inventors: Soo Jeon LEE, Daejeon (KR); Byoung Sun LEE, Daejeon (KR); Won Chan JUNG, Daejeon (KR); Jae Hoon KIM, Daejeon (KR)

(73) Assignee: Electronics and Telecommunications Research Institute, Daejon (KR)

(21) Appl. No.: 13/171,996

(22) Filed: Jun. 29, 2011

(30) Foreign Application Priority Data
Jul. 2, 2010 (KR) 10-2010-0063723
Dec. 21, 2010 (KR) 10-2010-0131494

(51) Int. Cl. G06F 15/16

(52) U.S. Cl. 709/205

(57) ABSTRACT

Provided is a cloud computing service providing system that may generate a list by classifying at least one information providing terminal based on platform information and content information received from the at least one information providing terminal, may provide the generated list to at least one user terminal, and, when a selection signal indicating that one of the at least one information providing terminal is selected by a user terminal, may connect the user terminal with the selected information providing terminal based on a peer-to-peer (P2P) scheme.

### CROSS-REFERENCE TO RELATED APPLICATION(S)

This application claims the benefit of Korean Patent Application Nos. 10-2010-0063723 and 10-2010-0131494, respectively filed on Jul. 2, 2010 and Dec. 21, 2010, in the Korean Intellectual Property Office, the disclosures of which are incorporated herein by references.

### BACKGROUND

1. Field of the Invention

The present invention relates to a system and method that provides a cloud computing service.

2. Description of the Related Art

A cloud computing environment is an environment in which computing resources are stored in a cloud which users may access on demand using a simple structured terminal so as to perform desired operations.

In the cloud computing environment, a terminal has a simple structure, so that an individual user may access the cloud using an inexpensive personal computer (PC). Also, the individual user may utilize a server computer that is most appropriate for an executed program, so that the user may not manage the PC such as purchasing of programs, storing data, and the like, and may not consider specifications of a memory, a central processing unit (CPU), a disk capacity, a peripheral device, and the like.

However, there are concerns about security, reliable communication and the like in the cloud computing environment.

One feature of a conventional cloud computing environment is that all computers constituting the cloud server are under the control of a service provider.

Although cloud servers are physically distributed, the cloud servers may be controlled by the center.

Research on a cloud service based on a peer-to-peer (P2P) scheme has been actively conducted, a goal of the research being to make a PC on the Internet act as a cloud server.

When compared to the central control cloud, the research may provide a relatively worse security, reliability, and fault tolerance, but may provide a relatively large amount of computing resource at a low cost.

### SUMMARY

According to an aspect of the present invention, there is provided a system for providing a cloud computing service, the system including at least one information providing terminal to provide platform information and content information associated with the at least one information providing terminal, a coordinator server to receive, from the at least one information providing terminal, the platform information and the content information, and to generate a list by classifying the at least one information providing terminal based on the platform information, and a user terminal to select one of the at least one information providing terminal included in the list, and to receive the content information by accessing the selected information providing terminal based on a peer-to-peer scheme.

Each piece of platform information may include at least one element of specification information of a network speed, an internet protocol (IP) address, an operating system (OS), a central processing unit (CPU), a random-access memory (RAM), and a hard disk drive associated with a corresponding information providing terminal, and reward information associated with providing of the content information.

The at least one information providing terminal may have platform information different from each other.

The at least one information providing terminal may access the coordinator server and provide the platform information, independently, and the coordinator server may update the list based on the platform information associated with the at least one information providing terminal.

The at least one information providing terminal may group at least two information providing terminals into a group, and may provide platform information associated with the grouped information providing terminals to the coordinator server, and the coordinator server may update the list based on the platform information provided from the grouped information providing terminals.

When an information providing terminal that is inaccessible due to an error exists among the grouped information providing terminals, the at least one information providing terminal may continuously provide the content information by connecting another information providing terminal to the user terminal.

The coordinator server may periodically determine whether the at least one information providing terminal is available, and may delete, from the list, platform information associated with an information providing terminal that is not available.

The coordinator server may exclude, from the list, platform information associated with an information providing terminal when the information providing terminal is accessed by the user terminal.

The at least one information providing terminal may receive, from the user terminal, a reward corresponding to the reward information, and may share the reward with the coordinator server at a predetermined ratio.

According to another aspect of the present invention, there is provided an apparatus for providing a cloud computing service, the apparatus including an information receiving unit to receive platform information and content information from at least one information providing terminal, a list generating unit to generate a list by classifying the at least one information providing terminal based on the platform information, and to provide the generated list to at least one user terminal, a selection signal receiving unit to receive a selection signal indicating that one of the at least one information providing terminal included in the list is selected by a user terminal, from the selected information providing terminal, and an access controller to control the information providing terminal that transmits the selection signal and the user terminal, to be connected based on a peer-to-peer scheme.

According to still another aspect of the present invention, there is provided a method of providing a cloud computing service, the method including receiving platform information and content information from at least one information providing terminal, generating a list by classifying the at least one information providing terminal based on the platform information, providing the generated list to at least one user terminal, receiving a selection signal indicating that one of the at least one information providing terminal included in the list is selected by a user terminal, from the selected information providing terminal, and controlling the information providing terminal that transmits the selection signal and the user terminal to be connected based on a peer-to-peer scheme.

The cloud computing service providing method may further include transmitting content information provided by the selected information providing terminal to the user terminal that selects the information providing terminal.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a cloud computing service providing system according to an example embodiment of the present invention;

FIG. 2 is a block diagram illustrating a configuration of a cloud computing service providing apparatus according to an example embodiment of the present invention;

FIG. 3 is a flowchart illustrating a cloud computing service providing method according to an example embodiment of the present invention; and

FIG. 4 is a diagram illustrating signal processing between a user terminal and an information providing terminal which receives and provides information through a cloud computing service providing apparatus according to an example embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

A cloud computing service providing system may form a cloud by collecting resources of individual terminals, and users may access the cloud so as to obtain an environment for operation.

The cloud computing service providing system may provide a service using various terminals having varied specifications when compared to a conventional cloud.

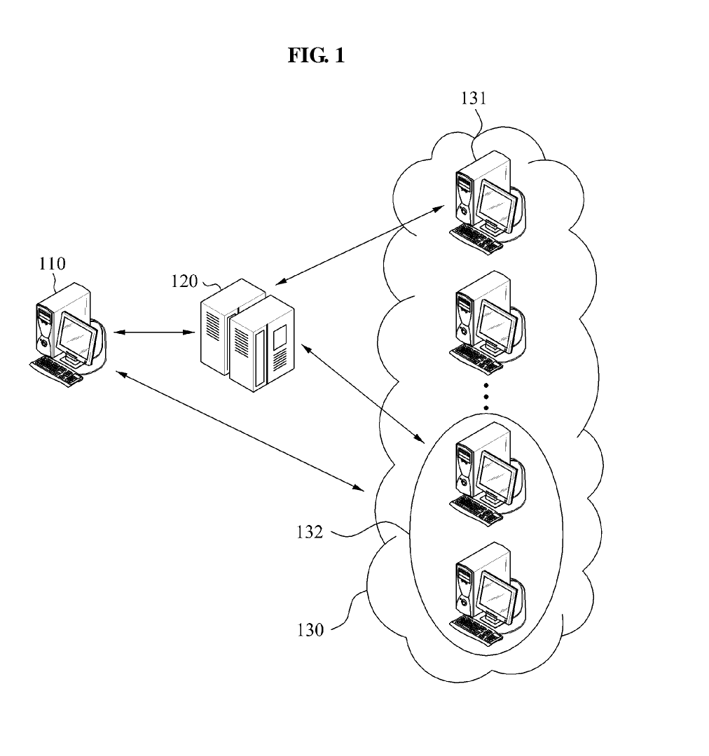

FIG. 1 illustrates a configuration of a cloud computing service providing system according to an example embodiment of the present invention.

The cloud computing service providing system may include a user terminal 110, a coordinator server 120, and at least one information providing terminal 130.

The at least one information providing terminal 130 may provide platform information and content information, respectively.

The coordinator server 120 may receive the platform information and the content information from the at least one information providing terminal 130, and may classify the at least one information providing terminal 130 based on the platform information so as to generate a list.

The user terminal 110 may select one of the at least one information providing terminal 130, and may access the selected information providing terminal based on a peer-to-peer (P2P) scheme so as to receive content information.

When an information provider that plans to operate an information providing terminal, the information provider may install a client access software by accessing a predetermined website and downloading the client access software, and may drive the software so as to transmit platform information to the coordinator server 120.

Each piece of platform information may include at least one element of specification information of a network speed, an IP address, an operating system (OS), a central processing unit (CPU), a random-access memory (RAM), and a hard disk drive associated with a corresponding information providing terminal, and may include reward information associated with providing of the content information, and the like.

The platform information provided from the at least one information providing terminal 130 may be different from each other and thus, various terminals having varied specifications may be provided as cloud terminals.

For example, the at least one information providing terminal 130 may provide the platform information, independently. Specifically, an information providing terminal 131 may independently access the coordinator server 120 so as to provide platform information, and the coordinator server 120 may update a list based on the platform information provided from the information providing terminal 131.

For another example, the at least one information providing terminal 130 may group at least two information providing terminals into a group, and may provide, to the coordinator server 120, platform information associated with the grouped information providing terminals 132. The coordinator server 120 may update the list based on the platform information provided from the grouped information providing terminals 132.

When an information providing terminal is inaccessible due to an error existing among the grouped information providing terminal 132, the at least one information providing terminal 130 may continuously transmit the content information by connecting another information providing terminal among the grouped information providing terminal 132 with the user terminal 110.

The coordinator server 120 may periodically determine whether the at least one information providing terminal 130 is available, and may delete, from the list, platform information associated with an information providing terminal that is not available.

The coordinator server 120 may exclude, from the list, platform information associated with an information providing terminal when the information providing terminal is accessed by the user terminal 110, so as to prevent another user terminal from selecting the accessed information providing terminal.

The at least one information providing terminal 130 may receive a reward corresponding to the reward information from the user terminal 110, and may share the provided reward with the coordinator server 120 at a predetermined ratio.

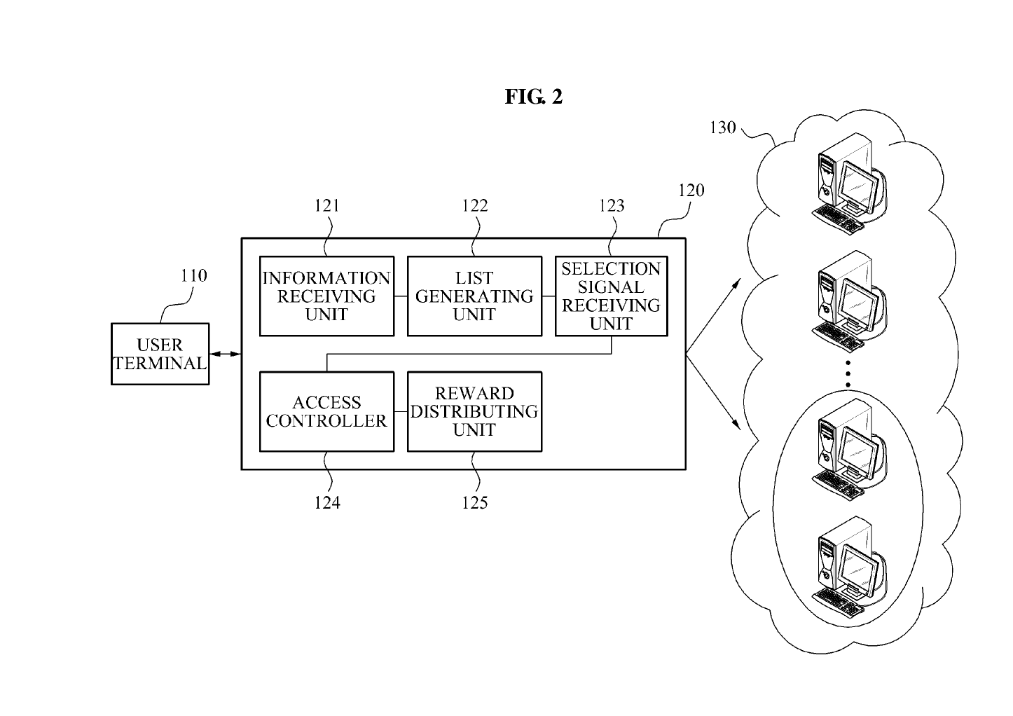

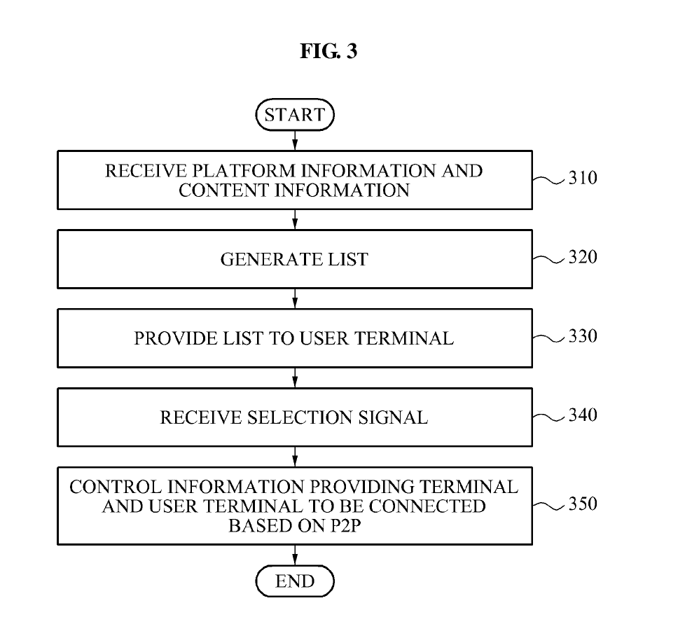

FIG. 2 illustrates a configuration of a cloud computing service providing apparatus according to an example embodiment of the present invention. FIG. 3 illustrates a cloud computing service providing method according to an example embodiment of the present invention.

Referring to FIGS. 2 and 3, a cloud computing service providing apparatus will be described in terms of the coordinator server 120. The cloud computing service providing apparatus may select a desired information providing terminal through the coordinator server 120 that manages a list including the at least one information providing terminal 130, and may provide content information from the selected information providing terminal based on a P2P scheme.

An information receiving unit 121 of the cloud computing service providing apparatus may receive platform information and content information from the at least one information providing terminal 130 in operation 310.

A list generating unit 122 may generate a list by classifying the at least one information providing terminal 130 based on the platform information in operation 320, and may provide the generated list to at least one user terminal, for example, the user terminal 110, in operation 330.

The list generating unit 122 may periodically determine whether the at least one information providing terminal 130 is available, and may delete, from the list, platform information associated with an information providing terminal that is not available.

The list generating unit 122 may exclude, from the list, platform information associated with an information providing terminal when the information providing terminal is accessed by the user terminal 110.

When one of the at least one information providing terminal 130 is selected by the user terminal 110, a selection signal receiving unit 123 of the cloud computing service providing apparatus may receive a selection signal indicating that the information providing terminal is selected by the user terminal 110 from the selected information providing terminal in operation 340.

An access controller 124 may control the information providing terminal that transmits the selection signal and the user terminal 110 to be connected based on a P2P scheme in operation 350.

A reward distributing unit 125 may receive a reward corresponding to reward information from the user terminal 110, and may share the reward with the at least one information providing terminal 130 at a predetermined radio.

Hereinafter, a signal transmission and reception process between devices included in a cloud computing service providing system will be described.

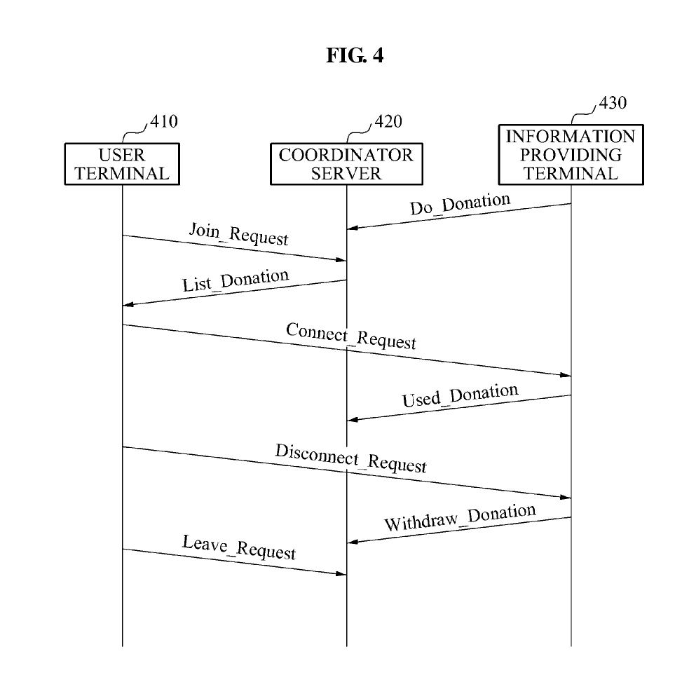

FIG. 4 illustrates signal processing between a user terminal and an information providing terminal which receives and provides information through a cloud computing service providing apparatus according to an example embodiment of the present invention.

Referring to FIG. 4, at least one information providing terminal, for example an information providing terminal 430, may transmit platform information to a coordinator server 420 before software enabling access to the coordinator server 420 is operated.

According to an aspect of the present invention, a start message to be used for transmitting the platform information from the information providing terminal 430 to the coordinator server 420 may be referred to as a Do_Donation message.

For example, when a single terminal or a virtual machine (VM) is used as the information providing terminal 430, the Do_Donation message may include information as shown in Table 1.

TABLE 1

| | | | | | |
|---|---|---|---|---|---|
| Price | Network | Address | CPU | Memory Spec. | Disk Spec. |
| | capa. | | Spec. | | |

Here, “Price” may denote a reward that the information providing terminal 430 requests, for providing information. “Price” may be determined based on a desired price of an information provider or may be determined based on a fee charged on an hourly basis.

“Network Capa.” may denote a network speed, “Address” may denote an address, such as an internet protocol (IP) address and the like. Also, “CPU spec.”, “Memory Spec.”, and “Disk Spec.” may denote specifications of a corresponding device.

According to an aspect of the present invention, a plurality of terminals may be grouped and may be designated as grouped information providing terminals. When the do_Donation message is set by the plurality of terminals, the do_Donation message may include information as shown in Table 2 below.

TABLE 2

| | | | | | |
|---|---|---|---|---|---|
| Price | Network | Address 1 | CPU | Memory Spec. 1 | Disk Spec. 1 |
| | Capa. 1 | | Spec. 1 | | |
| | Network | Address 2 | CPU | Memory Spec. 2 | Disk Spec. 2 |
| | Capa. 2 | | Spec. 2 | | |
| | . . . | . . . | . . . | . . . | . . . |
| | Network | Address N | CPU | Memory Spec. N | Disk Spec. N |
| | Capa. N | | Spec. N | | |

The coordinator server 420 may update and manage a list based on platform information after receiving the do_Donation message from the at least one information providing terminal, for example, the information providing terminal 430.

The information providing terminal 430 may transmit a Withdraw_Donation message to the coordinator server 420 to withdraw the Do_Donation message when the information providing terminal 430 desires to withdraw the Do_Donation message.

The Withdraw_Donation message may include an “Address” of the user terminal 410 to which the information providing terminal 430 transmits the Do_Donation message, or may include a predetermined key value in the list as shown in Table 3 below.

TABLE 3

| | | | |
|---|---|---|---|
| Address 1 | Address 2 | . . . | Address N |

When the information providing terminal 430 accesses a predetermined user terminal, for example, the user terminal 410, so as to provide an information providing service, the information providing terminal 430 may transmit a Used_Donation message to the coordinator server 420 so as to state that the corresponding information providing terminal is accessed by the user terminal 410 and transmits content information.

When the information providing terminal 430 receives a Disconnect_Request message from the user terminal 410, the information providing terminal 430 may inform the coordinator server 420 that the information providing terminal 430 is able to provide a service by maintaining a connection with another user terminal.

For example, the information providing terminal 430 may transmit a Withdraw_Donation message to the coordinator server 420, and transmits a Do_Donation message again so as to prepare for information providing service again.

According to an aspect of the present invention, the user terminal 410 may refer to the list provided from the coordinator server 420, so as to access the at least one information providing terminal and to obtain information.

For example, a service user may access a website and the like operated by the coordinator server 420 and may check the list.

The service user may select an information providing terminal, for example, the information providing terminal 430, or one of a grouped information providing terminals, and may request service from the coordinator server 420.

For example, the user terminal 410 may transmit a join_request message to the coordinator server 420 so as to request a service.

The user terminal 410 may obtain, from the coordinator server 420, information associated with at least one information providing terminal through a list included in a list_donation message, may select an information providing terminal, for example, the information providing terminal 430, and may access the selected information providing terminal 430.

For example, the user terminal 410 may transmit, to the selected information providing terminal 430, a Connect_Request message for requesting an information providing service from the selected information providing terminal 430.

The user terminal 410 may complete an operation by utilizing the selected information providing terminal 430, may transmit a Disconnect_Request message, and may transmit a Leave_Request message to the coordinator server 420 so as to release the access to the selected information providing terminal 430.

According to an aspect of the present invention, the coordinator server 420 may maintain and manage a list associated with at least one information providing terminal, and may continuously determine whether the least one information providing terminal is available.

For example, the coordinator server 420 may periodically check with respect to the least one information providing terminal through a probing scheme and the like, since the least one information providing terminal may be abnormally terminated without transmitting a Withdraw_Donation message.

The coordinator server 420 may delete, from the list, an information providing terminal that is not available. When the coordinator server 420 receives a Used_Donation message from an information providing terminal, the coordinator server 420 may determine that the information providing terminal is accessed by the user terminal 410 and may exclude, from the list provided to the user terminal 410, information associated with the information providing terminal.

The list may be provided to the terminal 410 through a website and the like. The user terminal 410 may receive the list and may transmit a Join_Request message to the coordinator server 420 to select an information providing terminal, for example, the information providing terminal 430.

When the coordinator server 420 receives a request for information associated with an information providing terminal 430, the coordinator server 420 may check whether the information providing terminal 430 is available and may connect the information providing terminal 430 and the user terminal 410 when the information providing terminal 430 is available.

The user 410 may transmit a Connect_Request message to the information providing terminal 430 and may access the information providing terminal 430.

According to an example embodiment of the present invention, a cloud is formed by collecting resources of individual terminals, and users may access the cloud so as to obtain an environment for operation. Therefore, various cloud environments may be provided by utilizing various specifications of the individual terminals.

According to an example embodiment of the present invention, users may be provided with a cloud service at a low cost, and an information providing terminal that provides a cloud service may generate profits by sharing, with a coordinator service, a reward for providing the service.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A system for providing a cloud computing service, the system comprising:
at least one information providing terminal to provide platform information and content information associated with the at least one information providing terminal;
a coordinator server to receive, from the at least one information providing terminal, the platform information and the content information, and to generate a list by classifying the at least one information providing terminal based on the platform information; and
a user terminal to select one of the at least one information providing terminal included in the list, and to receive the content information by accessing the selected information providing terminal based on a peer-to-peer scheme.

2. The system of claim 1, wherein each piece of platform information comprises:
at least one element of specification information of a network speed, an internet protocol (IP) address, an operating system (OS), a central processing unit (CPU), a random-access memory (RAM), and a hard disk drive associated with a corresponding information providing terminal; and
reward information associated with providing of the content information.

3. The system of claim 2, wherein the at least one information providing terminal has platform information different from each other.

4. The system of claim 1, wherein:
the at least one information providing terminal accesses the coordinator server and provides the platform information, independently; and
the coordinator server updates the list based on the platform information associated with the at least one information providing terminal.

5. The system of claim 1, wherein:
the at least one information providing terminal groups at least two information providing terminals into a group, and provides platform information associated with the grouped information providing terminals to the coordinator server; and
the coordinator server updates the list based on the platform information provided from the grouped information providing terminals.

6. The system of claim 5, wherein, when an information providing terminal that is inaccessible due to an error exists among the grouped information providing terminals, the at least one information providing terminal continuously provides the content information by connecting another information providing terminal to the user terminal.

7. The system of claim 1, wherein the coordinator server periodically determines whether the at least one information providing terminal is available, and deletes, from the list, platform information associated with an information providing terminal that is not available.

8. The system of claim 1, wherein the coordinator server excludes, from the list, platform information associated with an information providing terminal when the information providing terminal is accessed by the user terminal.

9. The system of claim 2, wherein the at least one information providing terminal receives, from the user terminal, a reward corresponding to the reward information, and shares the reward with the coordinator server at a predetermined ratio.

10. An apparatus for providing a cloud computing service, the apparatus comprising:
an information receiving unit to receive platform information and content information from at least one information providing terminal;
a list generating unit to generate a list by classifying the at least one information providing terminal based on the platform information, and to provide the generated list to at least one user terminal;
a selection signal receiving unit to receive a selection signal indicating that one of the at least one information providing terminal included in the list is selected by a user terminal, from the selected information providing terminal; and
an access controller to control the information providing terminal that transmits the selection signal and the user terminal, to be connected based on a peer-to-peer scheme.

11. The apparatus of claim 10, wherein each piece of platform information comprises:
at least one element of specification information of a network speed, an internet protocol (IP) address, an operating system (OS), a central processing unit (CPU), a random-access memory (RAM), and a hard disk drive associated with a corresponding information providing terminal; and
reward information associated with providing of the content information.

12. The apparatus of claim 10, wherein the list generating unit comprises:
periodically determining whether the at least one information providing terminal is available, and deletes, from the list, platform information associated with an information providing terminal that is not available.

13. The apparatus of claim 10, wherein the list generating unit comprises:
excluding, from the list, platform information associated with an information providing terminal when the information providing terminal is accessed by the user terminal.

14. The apparatus of claim 11, further comprising:
a reward distributing unit to receive, from the user terminal, a reward corresponding to the reward information, and to share with the at least one information providing terminal at a predetermined ratio.

15. A method of providing a cloud computing service, the method comprising:
receiving platform information and content information from at least one information providing terminal;
generating a list by classifying the at least one information providing terminal based on the platform information;
providing the generated list to at least one user terminal;
receiving a selection signal indicating that one of the at least one information providing terminal included in the list is selected by a user terminal, from the selected information providing terminal; and
controlling the information providing terminal that transmits the selection signal and the user terminal to be connected based on a peer-to-peer scheme.

16. The method of claim 15, further comprising:
transmitting content information provided by the selected information providing terminal to the user terminal that selects the information providing terminal.

17. The method of claim 15, wherein each piece of platform information comprises:
at least one element of specification information of a network speed, an internet protocol (IP) address, an operating system (OS), a central processing unit (CPU), a random-access memory (RAM), and a hard disk drive associated with a corresponding information providing terminal; and
reward information associated with providing of the content information.

18. The method of claim 15, further comprising:
periodically determining whether the at least one information providing terminal is available;
deleting, from the list, platform information associated with a terminal that is not available among the at least one information providing terminal.

19. The method of claim 15, further comprising:
excluding, from the list, platform information associated with an information providing terminal when the information providing terminal is accessed by the user terminal.

20. The method of claim 17, further comprising:
receiving a reward corresponding to the reward information from the user terminal, and sharing the reward with the at least one information providing terminal at a predetermined ratio.
